(19) United States
(12) Patent Application Publication
(10) Pub. No.: US 2009/0063358 A1
(43) Pub. Date: Mar. 5, 2009

(54) METHOD AND SYSTEM OF PRICING EXOTIC OPTIONS

(75) Inventor: Kurt Smith, Floreat (AU)

Correspondence Address: EDWARDS ANGELL PALMER & DODGE LLP, P.O. BOX 55874, BOSTON, MA, 02205, US

(73) Assignee: CURTIN UNIVERSITY OF TECHNOLOGY, Western Australia (AU)

(21) Appl. No.: 11/631,251

(22) PCT Filed: Jun. 28, 2005
(86) PCT No.: PCT/AU2005/000944

§ 371 Date: Oct. 22, 2008

(30) Foreign Application Priority Data
Jun. 29, 2004 (AU) 2004903513

(51) Int. Cl. G06Q 40/00

(52) U.S. Cl. 705/36 R; 705/37

(57) ABSTRACT

A system for calculating a market value of an exotic option comprises an input means (102) for receiving market and option contract input data (112); a means (104) for calculating a theoretical value of an exotic option from the input data; a means (104) for calculating a market supplement adjustment to the theoretical value as a function of the expected stopping time of the exotic option; a means (104) for applying the market supplement adjustment to the theoretical value to produce the market value; and an output means (106) for outputting the calculated market value. The system may also calculate bid and offer prices from the market value. A method of obtaining the market value of an exotic option and a method of obtaining bid and offer prices of an exotic option are also disclosed.

### FIELD OF THE INVENTION

The present invention relates to a method and system for pricing financial derivatives more specifically exotic options.

### BACKGROUND

Options are derivative securities whose values are a function of an underlying asset.

The price of an underlying asset for immediate purchase is called the spot price. A vanilla option on an (underlying) asset gives the buyer the right, but not the obligation, to buy (Call) or sell (Put) the underlying asset at the strike price. Where options are traded the price-maker prepares a bid price and an offer price. The bid price is the price at which the trader is willing to purchase the option and the offer price is the price at which the trader is willing to sell the option. The difference between the bid and offer prices is referred to as the bid-offer spread.

In the early 1970s Black and Scholes, and Merton, independently developed an option pricing model that is still in use today. The BSM model, as it is commonly known, provides unique closed form solutions for the price of European vanilla options. BSM found that by constructing and dynamically maintaining an option replication portfolio consisting of assets whose prices are known, they could obtain a precise option price by exploiting the no-arbitrage condition.

The BSM model is limited in that it only values the convexity of the option delta with respect to the underlying asset price. Other crucial convexities in the real world are not priced by BSM models, such as vega and delta convexities to implied volatility. While attempts have been made to derive a model which endogenously values all key convexities, price-makers prefer the pragmatic approach of adjusting the BSM implied volatility to make the model work in practice. These adjustments are called smile and skew and are defined by vega neutral butterflies and risk reversals respectively.

A vega neutral butterfly is a trading strategy in which a strangle is purchased and a zero-delta straddle is sold, both with the same maturity date, such that the vega of the strategy starts at zero. A strangle is a trading strategy requiring the simultaneous purchase (or sale) of a Put option and a Call option, with identical face values and maturity dates but different strike prices, such that the delta of the strategy is equal to zero. A zero-delta straddle is a trading strategy requiring the simultaneous purchase (or sale) of a Put option and a Call option, with identical face values, maturity dates and strike prices, such that the delta of the strategy is equal to zero. A risk reversal is a trading strategy in which a Call (Put) option is purchased and a Put (Call) option is sold, where both have identical deltas, maturity date and face value.

The BSM methodology has been applied to exotic as well as vanilla payoffs, to obtain the theoretical value of exotic options. For example, American binary options are amongst the most heavily traded exotic foreign exchange (FX) options. This is because in addition to being a popular product in their own right, they are also a crucial component of the popular reverse and regular barrier options. In contrast to European vanilla options, American binary options terminate automatically if a touch level trades and they have discontinuous payoffs. The most traded American binary options are continuously monitored one touch (OT) and double-no-touch (DNT) options. A OT option obliges the writer to pay the buyer a fixed amount if the touch level trades in the market. The liability crystallises on the day the touch level trades, and is paid on the delivery date of the option. A DNT option obliges the writer to pay the buyer a fixed amount if the touch levels do not trade in the market. The touch levels are above and below the current spot exchange rate when the option is written and liability is crystallised at expiration and is paid on the delivery date of the option.

Option risks are described by a set of partial derivatives commonly referred to as “the Greeks”. Option Greeks include:
Delta: the amount that an option price will change given a small change in the price of the underlying asset. In otherwords it is the partial derivative of the option price which respect to the spot asset price; and
Vega: the amount that an option price will change given a small change in volatility. In otherwords it is the partial derivative of the option price with respect to volatility.

Just as the BSM methodology must be modified to price vega and delta convexities of implied volatility for European vanilla options, the theoretical valuation of exotic options must also be adjusted to reflect the benefits or costs of these additional convexities of implied volatility. The adjustment is internally consistent with those for European vanilla options, but the size and/or sign of the adjustment is different.

Some of the approaches used in the FX market to-date to value exotic options are as follows:
analytical methods—analogously to their European vanilla counterparts some exotic FX option price-makers take the BSM theoretical model as an accurate value of the American binary option's delta convexity to the underlying exchange rate. They then value the market supplement to the theoretical value by calculating the value of vega convexity to implied volatility and delta convexity to implied volatility. The market supplement can be positive, negative or zero depending on spatial and temporal factors;
recombinant trees—binomial and trinomial trees in one or two dimensions are constructed to approximate numerically the price of the American binary option for a sample of time and space;

finite difference and finite element methods—in principle similar to trees but now forming a mesh of possible points in space and time. These methods are common when parameterising implied volatility as local volatilities;

Monte Carlo Simulation—simulations of the underlying exchange rate process are repeated manifold and a value of the American binary option is obtained for each exchange rate path. These values are averaged and discounted. This method is common for stochastic volatility models and universal volatility models.

The analytical method has been widely discredited, even though it has considerable intuitive appeal, because no one has been able to value a crucial risk correctly. As a result, analytical valuation models have hitherto only crudely approximated market value, owing to over-reliance upon estimation methods and/or arbitrary constants to weight the convexity adjustments.

International Patent Application No. PCT/IB01/01941 (WO 03/034297) of Superderivatives Inc. and GERSHON describes a process of pricing financial derivatives. The first problem with WO 03/034297 is that its broadest claims define known methods. The second problem is that it's model is dependent upon arbitrary constants. As a result, WO 03/034297 is only a crude approximation of market value and hence is not as accurate as the application purports it to be.

### SUMMARY OF THE PRESENT INVENTION

The present invention extends the analytical method of pricing derivatives to produce a model for determining market values and bid and offer prices of exotic options with increased accuracy and efficiency.

In accordance with the present invention there is provided a method of obtaining the market value of an exotic option, comprising the steps of:
providing market and option contract input data;
calculating a theoretical value of the exotic option from the input data;
calculating a market supplement adjustment to the theoretical value as a function of the expected stopping time of the exotic option; and
applying the market supplement adjustment to the theoretical value to produce the market value.

Typically the market value is used to calculate bid-offer prices. Preferably a bid-offer spread is calculated from the input data. Preferably the bid-offer spread is also a function of the expected stopping time of the exotic option. Preferably the bid and offer prices are calculated as a function of the market value and the bid-offer spread.

Typically an asymmetric slippage adjustment is calculated. Preferably the asymmetric slippage adjustment is calculated from the input data and a function of the expected stopping time of the exotic option. Preferably the bid and offer prices of the exotic option are calculated as a function of the market value, the bid-offer spread and the asymmetric slippage.

In accordance with the present invention there is provided a method of obtaining bid and offer prices of an exotic option, comprising the steps of:
providing market and option contract input data;
calculating a theoretical value of the exotic option from the input data;
calculating a market supplement adjustment to the theoretical value that incorporates the expected stopping time of the exotic option;
calculating the bid-offer spread from the input data and a function of the expected stopping time of the exotic option; and
calculating bid and offer prices of the exotic option as a function of the theoretical value, market supplement adjustment, and bid-offer spread.

Preferably adjusted bid-offer prices are calculated from an asymmetric slippage adjustment and the previously calculated bid-offer spread. Preferably the asymmetric slippage adjustment is calculated from the input data and a function of the expected stopping time of the exotic option.

Preferably the theoretical value is obtained by applying the no-arbitrage methods of Black-Scholes and Merton to exotic payoffs.

Preferably in calculation of the theoretical value, whenever the theoretical value of an option is dependent on the solution of an infinite sum, a finite number of elements are summed to ensure at least a five digit accuracy.

Preferably the market supplement adjustment is a function of the input data only.

Preferably the market supplement adjustment is calculated from a Convexity to Implied Volatility Adjustment and a Market Weight Adjustment.

Preferably the Convexity to Implied Volatility Adjustment is calculated with reference to the ∂vega/∂vol and ∂delta/∂vol of the exotic option, and of the relevant vega neutral butterfly and relevant risk reversal.

Preferably one of the steps of calculating the per unit price of ∂vega/∂vol is identifying the relevant vega neutral butterfly. Preferably the vega neutral butterfly is identified using a term to maturity equal to the expected stopping time of the exotic option and a minimum delta.

Preferably the minimum delta of the relevant vega neutral butterfly is chosen to match the delta of the touch level(s) at the expected stopping time. Preferably when there are two asymmetric touch levels, the minimum absolute delta is selected for the vega neutral butterfly.

Preferably the price per unit of vega convexity to implied volatility is calculated from the zeta of the vega neutral butterfly and its ∂vega/∂vol. Zeta(fly) is the different between the market value and the theoretical value of the relevant vega neutral butterfly.

Preferably one of the steps of calculating the per unit price of ∂delta/∂vol is identifying the relevant risk reversal. Preferably the risk reversal is identified using a term to maturity equal to the expected stopping time of the exotic option and the minimum delta.

Preferably the minimum delta of the equivalent risk reversal is chosen to match the delta of the touch level(s) at the expected stopping time. Preferably when there are two asymmetric touch levels, the minimum absolute delta is selected for the risk reversal.

Preferably the price per unit of delta convexity to implied volatility is calculated from the zeta of the risk reversal and its ∂delta/∂vol. Zeta(RR) is the different between the market value and the theoretical value of the relevant risk reversal.

Preferably the market weight adjustment is calculated from the expected stopping time of the exotic option and the nominal duration of the exotic option.

Preferably the market supplement adjustment is calculated from a vega convexity value and a delta convexity value. Preferably the vega convexity value is calculated from ∂vega/∂vol, the market weight adjustment, the per unit price of vega convexity and the touch probability. Preferably the delta convexity value is calculated from ∂delta/∂vol, the market weight adjustment, the per unit price of delta convexity and the touch probability.

Preferably a mid-market value is calculated from the theoretical value and the value of the market supplement adjustment.

Preferably the bid-offer spread is calculated such that it is independent of arbitrary constants and dependent only on the input data.

Preferably the bid-offer spread is calculated from a Static Spread Adjustment and a Dynamic Spread Adjustment. Preferably the Static Spread Adjustment includes a contribution from vega. Preferably the Static Spread Adjustment includes a contribution from ∂vega/∂vol. Preferably the Dynamic Spread Adjustment includes a contribution from ∂vega/∂vol. Preferably the Static Spread Adjustment includes a contribution from ∂delta/∂vol. Preferably the Dynamic Spread Adjustment includes a contribution from ∂delta/∂vol.

Preferably the Static Spread Adjustment includes a contribution from the expected life of the option. Preferably the Dynamic Spread Adjustment includes a contribution from the expected life of the option.

Preferably the bid-offer spread is supplemented by an asymmetric slippage component which has static and dynamic components.

Preferably bid and offer prices are calculated from the mid-market value and the supplemented bid-offer spread.

Preferably the methods described above are computer implemented.

According to another aspect of the present invention there is provided a system for calculating a market value of an exotic option comprising:
input means for receiving market and option contract input data;
means for calculating a theoretical value of an exotic option from the input data;
means for calculating a market supplement adjustment to the theoretical value as a function of the expected stopping time of the exotic option;
means for applying the market supplement adjustment to the theoretical value to produce the market value; and
output means for outputting the calculated market value.

According to a further aspect of the present invention there is provided a system for obtaining bid and offer prices of an exotic option comprising:
input means for receiving market and option contract input data;
means for calculating a theoretical value of an exotic option from the input data;
means for calculating a market supplement adjustment to the theoretical value that incorporates the expected stopping time of the exotic option;
means for calculating a bid-offer spread from the input data as a function of the expected stopping time of the exotic option;
means for calculating bid and offer prices of the exotic option as a function of the theoretical value, market supplement adjustment and bid-offer spread; and
output means for outputting the calculated bid and offer prices.

According to another aspect of the present invention there is provided a computer program for controlling a computer to perform any one of the above mentioned methods.

According to a further aspect of the present invention there is provided a computer program comprising instructions to operate a computer as one of the systems defined above.

According to a further aspect of the present invention there is provided a computer readable storage medium comprising a computer program as defined above.

### SUMMARY OF THE DIAGRAMS

In order to provide a better understanding of the present invention preferred embodiments will now be described, in greater detail, by way of example only, with reference to the accompanying figures, in which:

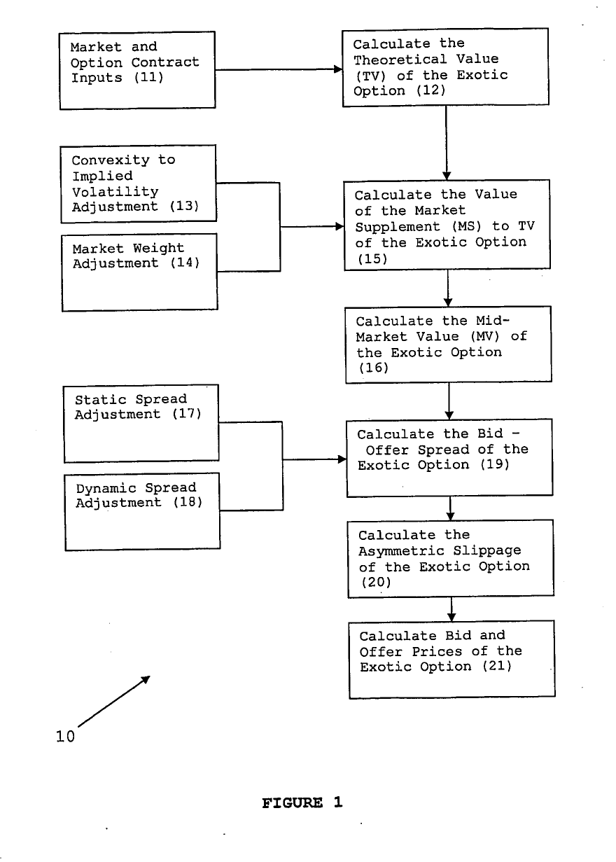

FIG. 1 is a flow chart of a method of pricing an exotic option according to a preferred embodiment of the present invention;

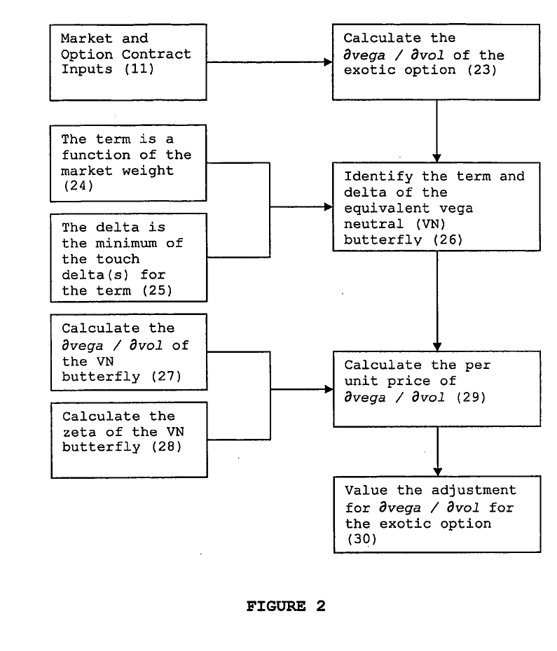

FIG. 2 is a flow chart of a method of calculating the vega convexity to implied volatility adjustment according to a preferred embodiment of the present invention;

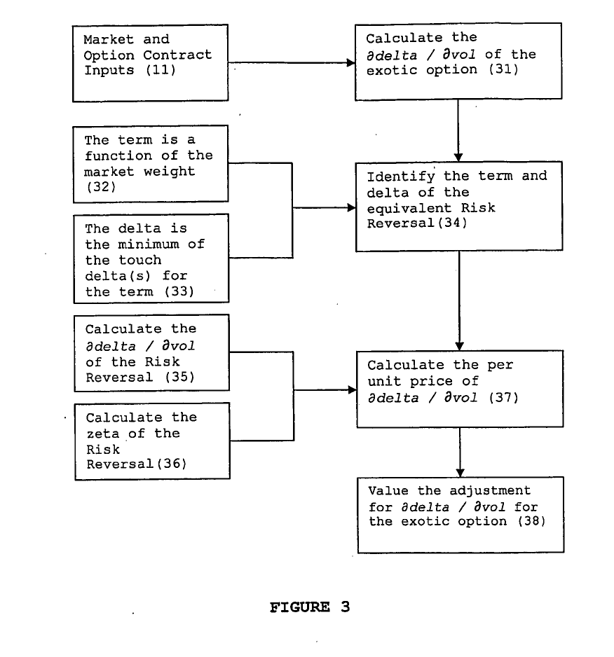

FIG. 3 is a flow chart of a method of calculating the delta convexity to implied volatility adjustment according to a preferred embodiment of the present invention;

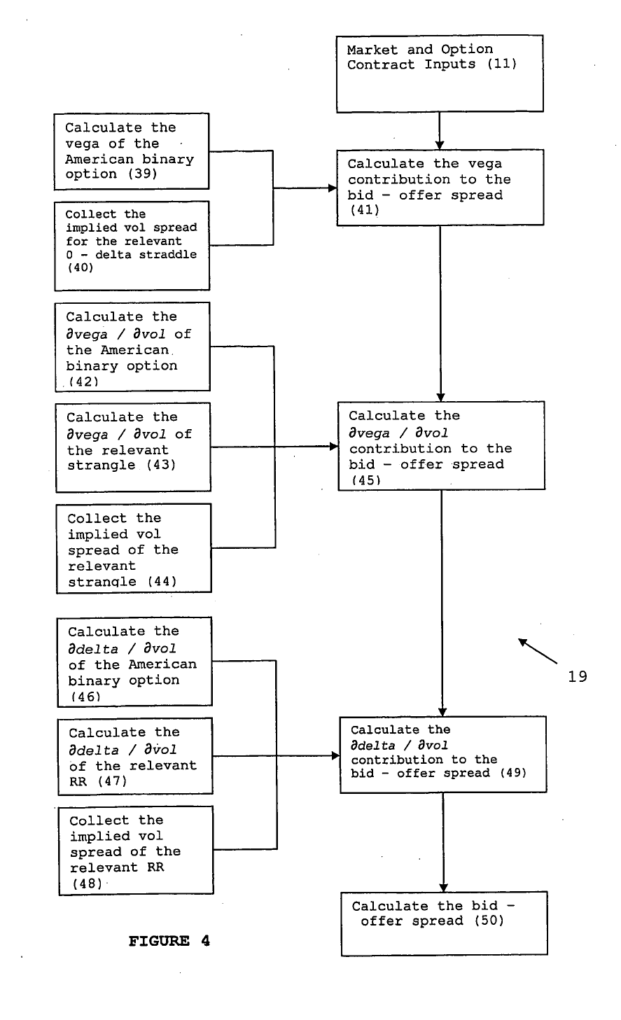

FIG. 4 is a flow chart of a method of calculating the bid-offer spread according to a preferred embodiment of the present invention;

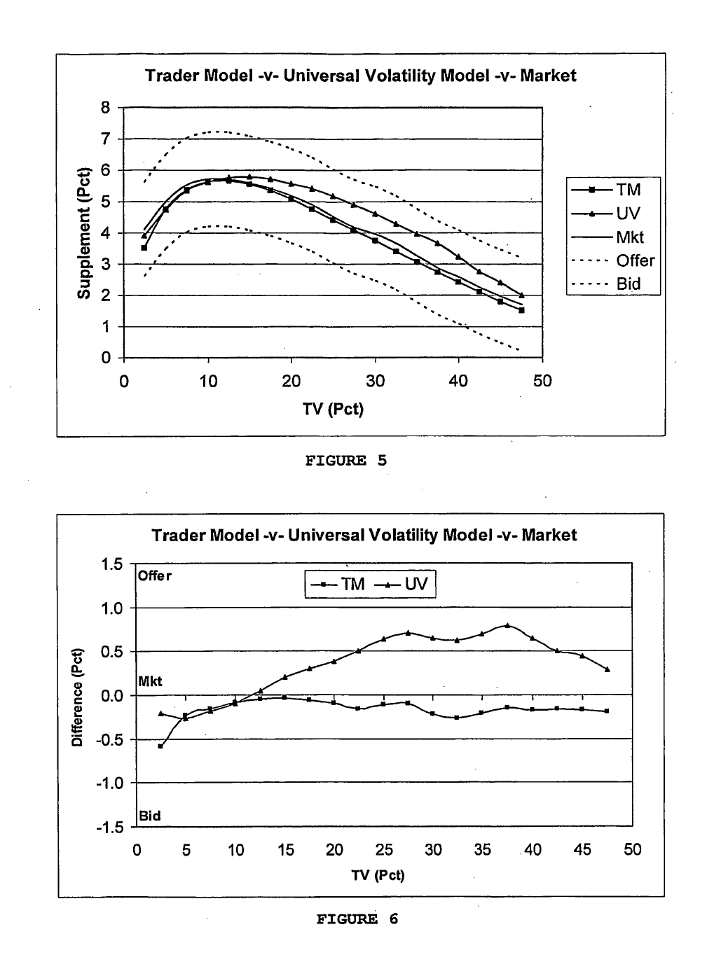

FIG. 5 is a diagram showing a comparison between a highly regarded model, the Universal Volatility Model, used in the art, actual market values and values calculated by a model created according to a preferred embodiment of the present invention;

FIG. 6 is a diagram showing a comparison between differences between the Universal Volatility Model and actual market values and differences between values calculated by a model created according to a preferred embodiment of the present invention and actual market values;

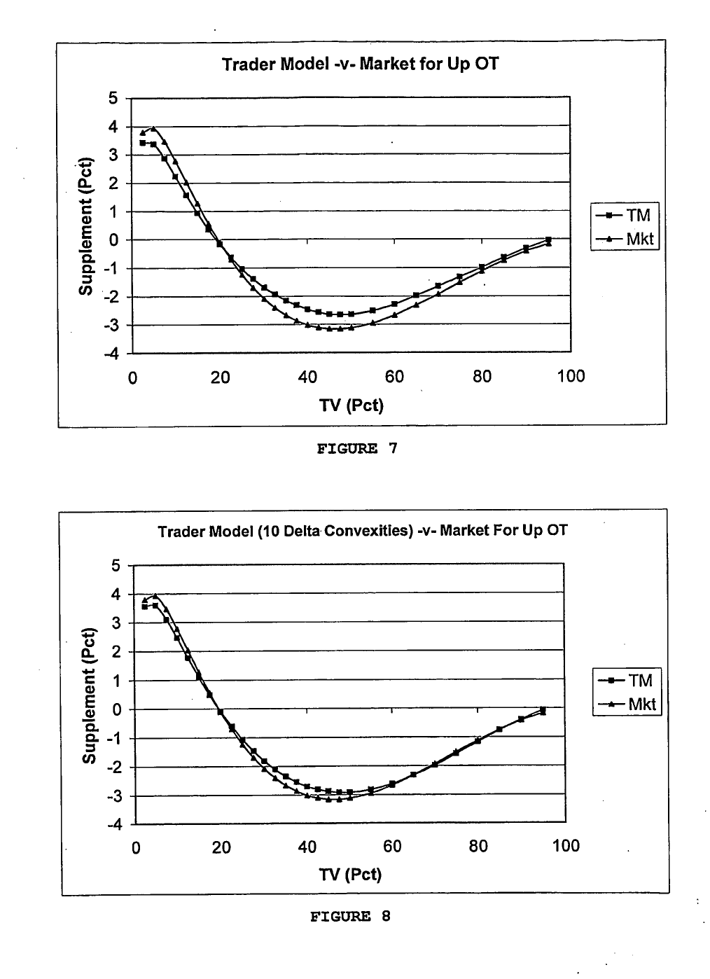

FIG. 7 is a diagram showing a comparison between values calculated according to a model created according to a preferred embodiment of the present invention and a competitor model used widely in the market;

FIG. 8 is a diagram showing another comparison between values calculated according to a model created according to a preferred embodiment of the present invention and a competitor model used widely in the market, which explains a key difference between them;

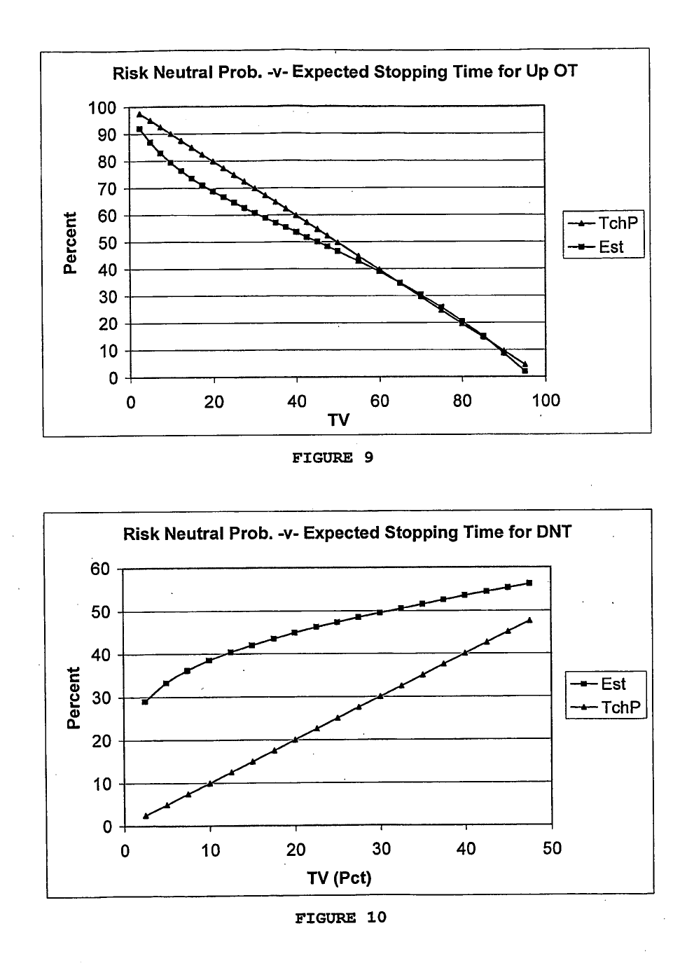

FIG. 9 is a diagram showing a comparison between risk neutral touch probabilities and expected stopping time for a one touch option for a preferred embodiment of the present invention which explains the remaining difference between values obtained from the present invention and the competitor model;

FIG. 10 is a diagram showing a comparison between risk neutral touch probabilities and expected stopping time for a double no touch option for a preferred embodiment of the present invention which shows why, unlike the present invention, the competitor model cannot be used to price all American exotic options;

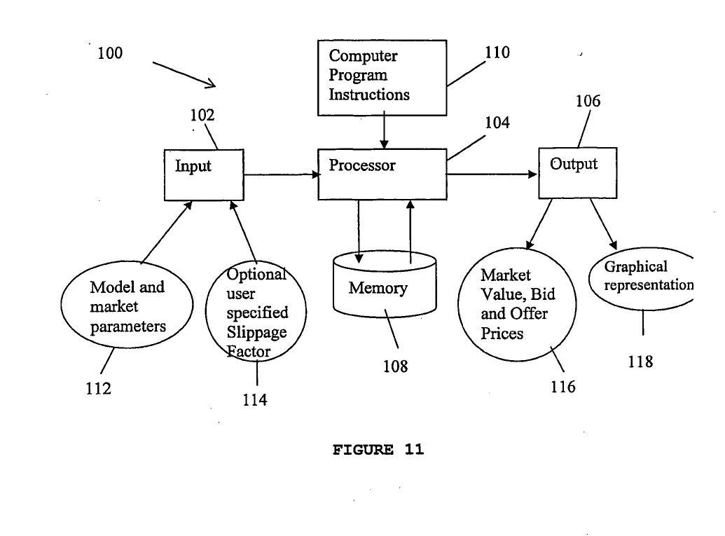

FIG. 11 is a schematic block diagram showing a computing means configured to operate as a preferred embodiment of a system of the present invention.

### DETAILED DESCRIPTION OF PREFERRED EMBODIMENT

The market value of exotic options is almost always different to the theoretical value, and often by a substantial amount. Exotic option theoretical values are obtained by applying the no-arbitrage methods of Black-Scholes and Merton to exotic payoffs. However, it is common knowledge in the market that the BSM specification of uncertainty is a very limited approximation of reality. As a result, models have been developed to price other factors which are important to the market. At the core of the present invention is a unique weighting scheme for valuing factors not priced by BSM, which is a function of the option and the market only. That is, the features of the option and the state of the market collectively and uniquely determine the weight of the factors driving the market price. This unique weighting scheme makes redundant the plethora of arbitrary and theoretically baseless constants which are a prominent feature of other approaches.

Referring to FIG. 1, the present invention provides a method 10 for obtaining the market price of exotic options. The method 10 is embodied in a computer program for controlling a computer to perform the method as described further below.

The method 10 of the present invention requires as inputs 11 the usual model and market parameters typical of all option pricing models. For example, an exotic FX option will require some or all of the following inputs to produce a unique price. This list is indicative not exhaustive:
spot exchange rate;
touch level(s);
strike price;
domestic and foreign interest rates;
expiry date; and
implied volatility surface.

The next step 12 is to calculate the theoretical value of the exotic option. Theoretical values for exotic options are well known in the market. Algorithms for valuing exotic options in a Black-Scholes framework have been published in academic journals. For example, pricing algorithms for the theoretical value of American binary and barrier options, which together constitute approximately 90% of the traded volume in exotic FX options, were published a decade ago. Rubinstein and Reiner (1991) published pricing formulae for OT options, and Kunitomo and Ikeda (1992) and Hui (1996) published DNT option pricing formulae.

The theoretical value only requires the implied volatility of the zero-delta straddle at the expiry date, the model of the present invention requires the full implied volatility surface, which defines implied volatility as a function of term and delta.

Whenever the theoretical value of an option is dependent on the solution of an infinite sum, a finite number of elements are summed to ensure five digit accuracy (0.00001) to conform with market convention. For example, a double no touch (DNT) option requires the solution of an infinite sum to obtain the theoretical value.

This is crucial, as short-dated DNT options, for example, can require many more than 10 elements to converge satisfactorily. With option market data from 2002, 30 elements were required to achieve five digit accuracy for a one week EUR/USD DNT option. In fact, for this data, all options shorter than two months maturity required more than 10 elements to be sufficiently accurate.

The next step 15 is to calculate the value of the Market Supplement to the Theoretical Value from the Convexity to Implied Volatility Adjustment 13 and Market Weight Adjustment 14. The value of the market supplement prices those factors which are essential to the market but trivial in BSM theory. The weighting scheme of the present invention is extremely simple and is a function of both the option contract specifications and the state of the market. This difference is crucial to the market, because price-makers (correctly) view arbitrary constants as a significant deficiency in a model used for pricing and/or risk managing exotic options.

The Convexity to Implied Volatility Adjustment is calculated at 13 using the processes of FIGS. 2 and 3.

When pricing exotic options to market, there are two key convexities which the classical BSM methodology does not price. Both involve convexity to implied volatility (vol), and they are known as ∂vega/∂vol and ∂delta/∂vol. The process for quantifying the ∂vega/∂vol adjustment is shown in FIG. 2. The process is identical for ∂delta/∂vol, except that one substitutes references to ∂vega/∂vol with ∂delta/∂vol, and references to vega neutral (‘VN’) butterfly with risk reversal (‘RR’) and is shown in FIG. 3.

Referring to FIG. 2, the vega convexity to implied volatility of the exotic option is computed at 23. It can be computed analytically or numerically from the market and option contract inputs 11, without affecting the performance of the method.

The relevant vega neutral butterfly is identified at 26. This is identified using a term to maturity equal to the expected stopping time of the exotic option 24. The expected stopping time for most American exotic options traded in the market is considerably shorter than their nominal duration.

The delta of the equivalent vega neutral butterfly is chosen at 25 to match the delta of the touch level(s) at the expected stopping time. If there are two asymmetric touch levels, the minimum absolute delta is selected for the vega neutral butterfly.

The ∂vega/∂vol of the VN butterfly is calculated at 27 and the zeta of the VN butterfly is calculated at 28. The zeta of the vega convexity to implied volatility is the difference between the market value and the theoretical value of the relevant vega neutral butterfly. Therefore, the zeta of the vega convexity measures the impact of the smile of the implied volatility surface on traded European vanilla prices.

The per unit price of vega convexity to implied volatility is calculated at 29 as follows:

Per Unit Price of Vega Convexity to

$$Implied Volatility = \frac{VNFlyZeta}{\frac{\partial vega}{\partial vol}}$$

Therefore, the per unit price of vega convexity reflects the delta and term of the relevant vega neutral butterfly and is appropriate for the touch level(s) and the expected stopping time of the exotic option.

Referring to FIG. 3, the delta convexity to implied volatility of the exotic option is computed at 31 from the market and option contract inputs 11.

The relevant risk reversal is identified at 34 using a term to maturity equal to the expected stopping time of the exotic option 32.

The delta of the equivalent risk reversal is chosen at 33 to match the delta of the touch level(s) at the expected stopping time. If there are two asymmetric touch levels, the minimum absolute delta is selected for the risk reversal.

The ∂delta/∂vol of the risk reversal is calculated at 35 and the zeta of the risk reversal is calculated at 36.

The per unit price of delta convexity to implied volatility is calculated at 37 as follows:

Per Unit Price of Delta Convexity to

$$Implied Volatility = \frac{RR Zeta}{\partial delta \text{/} \partial vol}$$

The zeta of the delta convexity to implied volatility is the difference between the market value and the theoretical value of the relevant risk reversal. Therefore, the zeta of the delta convexity measures the impact of the skew of the implied volatility surface on traded European vanilla option prices. The delta and term of the risk reversal is appropriate for the touch level(s) and the expected stopping time of the exotic option.

The value of the adjustment for ∂vega/∂vol and ∂delta/∂vol produced at 13 in FIG. 1 from 30 and 38 in FIGS. 2 and 3 is provided as an input to step 15.

The Market Weight Adjustment is calculated at 14.

American exotic options can disappear prior to expiry. The probability of their touch level(s) being hit can be computed from well known algorithms. One method (Wystup) for obtaining the market price of exotic options is to weight convexities to implied volatility by the touch probability. This method is a reasonable approximation for some exotics, and an extremely poor approximation of others.

The present invention weights the ∂vega/∂vol and ∂delta/∂vol of the exotic option by the expected stopping time of the exotic option. Algorithms for the expected stopping time for single and double touch levels are readily available. For example: Taleb (1997) and Shevchenko (2003).

The present invention recognises that the expected stopping time is the correct variable by which exotic convexities to implied volatility ought to be weighted.

The market weight adjustment 14 is calculated as follows:

$$Market Weight Adjustment = \frac{Expected Stopping Time of the Exotic Option}{Nominal Duration of the Exotic Option}$$

If the expected stopping time algorithm is normalised by the touch probability, then the market weight adjustment (MWA) needs to be multiplied by the touch probability of the exotic option:

$$M W A = \frac{Expected Stopping Time}{Nominal Duration} \times Touch Probability$$

Both expected stopping time and touch probability are those derived in a risk neutral world.

Having calculated the size of the convexities to implied volatility for the exotic option, their price per unit, and the market weight adjustment, it is possible to value the adjustment at 15 as follows:

Vega Convexity Value (VCV) is calculated.

VCV=Exotic Option ∂vega/∂vol×MWA×per unit price of vega convexity

Delta Convexity Value (DCV) is calculated.

DCV=Exotic Option ∂delta/∂vol×MWA×per unit price of delta convexity

The value of the market supplement (MS) then becomes 15:

MS=VCV+DCV

It is important to note that MS, VCV and DCV can be positive, negative or zero, depending on the option characteristics and the state of the market.

Having calculated the market supplement, the mid-market value (MV) of the exotic option is calculated at 16 as follows:

MV=TV+MS

where TV is the Theoretical Value.

Since MS can be positive, negative or zero, it follows that the mid-market value of the exotic option can be greater, lesser, or the same as the theoretical value.

It is essential for the medium- to long-term viability of an exotic option price-making desk that bid-offer spreads reflect the size and type of risk in the option market at the time a price is made. For this to be the case, bid-offer spreads must be independent of arbitrary constants and dependent only on the state of the market. Bid-offer spreads obtained using the present invention exhibit these crucial qualities.

The bid-offer spread is calculated at 19 from a Static Spread Adjustment 17 and a Dynamic Spread Adjustment 18 in FIG. 1 as shown in the schematic diagram of FIG. 4.

### Contribution of Vega to the Bid-Offer Spread

Vega makes a static and dynamic contribution to the size of the bid-offer spread. Just as the expected stopping time is crucial for pricing American binary options, it is also essential for calculating the appropriate spread.

The vega of the American binary option (VAB) is calculated at 39 as follows:

$$V A B = Vega T V \times \frac{Expected Stopping Time}{Nominal Duration}$$

That is, the theoretical vega of the American binary option is weighted by the proportional expected life of the option.

The Implied Volatility Spread for a Zero Delta Straddle (IVStraddle) is collected at 40. The implied volatility spread for zero delta straddles in the FX option market is a function of maturity. For example, the implied volatility spread for a three month straddle may be 0.20%, but a one week straddle may be 0.70%. For the purposes of calculating the bid-offer spread of an American binary option, the zero delta straddle of interest is the maturity which matches the expected stopping time of the American binary option.

The static vega contribution (SVC) to the bid-offer spread is calculated at 41 in FIG. 4 as follows:

SVC=|VAB×IVStraddle|

The algorithm is an absolute value, because each contribution effectively requires a hedge which incurs a cost. In this respect, netting of risk is a price phenomenon, not a spread phenomenon. As a result, the weighted vega of the American binary option is a multiple or fraction of, or the same as the ‘cost’ of European vanilla vega exposure, depending upon the option contract specifics and the state of the market.

The dynamic vega contribution (DVC) acknowledges that as implied volatility changes, so too does the vega of the American binary option. This effect is captured by ∂vega/∂vol, which is covered below. To avoid double-counting, DVC is set equal to zero.

The total vega contribution (TVC) to the bid-offer spread of the American binary option is the sum of the static and dynamic components, as follows:

TVC=SVC+DVC

The Contribution of ∂vega/∂vol to the Bid-Offer Spread is calculated at 45. ∂vega/∂vol makes a static and dynamic contribution to the size of the bid-offer spread of the American binary option.

The step at 42 is to calculate the ∂vega/∂vol of the American Binary Option (DVAB). The ∂vega/∂vol of the American binary option is weighted by the expected stopping time, and is calculated at 42 as follows:

$$D V A B = American Binary \partial vega \text{/} \partial vol \times \frac{Expected Stopping Time}{Nominal Duration}$$

The step at 43 is to calculate the ∂vega/∂vol of the Relevant Strangle (DVStrangle). The relevant strangle is the maturity which matches the expected stopping time of the American binary option, and the delta is the minimum delta of the touch level(s).

The step at 44 is to collect the Implied Volatility Spread of the Relevant Strangle (IVStrangle). The implied volatility spread for the relevant strangle is collected from the market and stored in tabular form, or other form as the case may be.

At step 45 the Static ∂vega/∂vol Contribution (SDVAB) and Dynamic ∂vega/∂vol Contribution (DDVAB) is calculated. The static ∂vega/∂vol contribution to the bid-offer spread is calculated at 45 as follows:

$$S D V A B = \vert \frac{D V A B}{D VStrangle} \times StrangleVega \times IVStrangle \vert$$

The ∂vega/∂vol of the American binary option and the ∂vega/∂vol of the strangle both change when implied volatility changes. The dynamic contribution to the spread accounts for this variation is also calculated at 45 as follows:

$$D D V A B = \vert \frac{D V A B + Λ}{DVStrangle + Ψ} \times StrangleVega \times IVStrangle \vert - S D V A B$$

Where Λ and Ψ are the respective changes in American binary and strangle ∂vega/∂vol caused by a change in implied volatility.

The total contribution of ∂vega/∂vol (TDVAB) to the bid-offer spread of an American binary option completes the calculation at 45 as follows:

TDVAB=SDVAB+DDVAB

The Contribution of ∂delta/∂vol to the Bid-Offer Spread is calculated at 46, 47, 48 and 49. The total contribution of ∂delta/∂vol (TDDAB) to the bid-offer spread of the American binary option is calculated in the same way as ∂vega/∂vol, except, references to ∂vega/∂vol are replaced with ∂delta/∂vol, and references to strangles are replaced with risk reversals.

The bid-offer spread (BOSpread) of the American binary option is the sum of each of the contributions and is calculated at 50 as follows:

BOSpread=TVC+TDVAB+TDDAB

The bid price and offer price can be calculated from the mid-market value and the BOSpread. It is preferred, but not essential, to factor in discontinuity risk via asymmetric slippage. Slippage is calculated separately at 20 (in FIG. 1) as it is asymmetric. An American binary option hitherto dynamically delta hedged will be exposed to spot rate changes if the touch level trades, because the option's delta immediately becomes zero. In theory, the price-maker unwinds all of the remaining delta hedge at the touch level by trading in the spot market. In practice, even American binary options with modest payouts can produce significant spot delta discontinuities, such that it is unlikely that all spot deltas can be executed precisely at the touch level. Slippage allows for execution costs incurred when unwinding the spot delta hedge at a spot rate worse than the touch level. The asymmetry stems from the fact that a price-maker's main concern is being short (long) spot deltas in a rising (falling) market. For example:

The buyer of a one touch option is more concerned than a seller if the touch level trades in the spot market, from a delta unwind perspective. When the American binary option terminates its delta becomes zero, leaving the remaining spot delta exposure short in a rising market (up OT) or long in a falling market (down OT) This problem is not as acute for a OT seller, as the spot delta unwind is against the direction of the market, not contributing to it. Conversely, it is the seller of a double-no-touch option which incurs the brunt of slippage costs.

Therefore, the bid of the OT is reduced, and the offer of the DNT is increased, to compensate for slippage risk. The methodology of the present invention gives the user the ability to price ‘normal’ slippage as well as ‘extraordinary’ slippage.

The method requires the slippage factor and size of the discontinuity level to be determined.

The user specifies the slippage factor (‘SF’). If a price-maker is asked to price an American binary option where a touch level is in a high risk zone (high concentration of touch levels in close vicinity in the actual market), the user will increase the slippage factor. ‘Normal’ is generally accepted as 2% and panic can be as much as 10% (Taleb, 1997).

The size of the discontinuity (‘SD’) is the size of the spot delta to be unwound when the touch level trades. Traditionally, popular interbank exotic FX option software calculates the size of the discontinuity by assuming that the exotic option approaches the touch level one day prior to its (nominal) expiration. This is the worst case scenario. For American binary options, this naive approach systematically overstates slippage risk because in every practical instance the expected stopping time of the American binary option will be shorter than its nominal duration. In the present invention, overstatement is avoided by making the slippage risk a function of the discontinuity at the expected stopping time of the exotic option. Comment: the deleted para refers to the other, less preferred approach, which is why I have deleted it.

The discontinuities at the expected stopping time is calculated by using forward interest rates and forward implied volatilities defined by the spot term structures of interest rates and the spot implied volatility surface. The size of the discontinuity is the difference in the spot delta of the American binary option between the expected stopping time and one day prior, when the spot level changes (sm) by the minimum of one day volatility (odv) and the distance between the spot rate and the touch level(s), to exactly on, the touch level(s):

$$o d v = \frac{{v}_{fwd}}{\sqrt{bizdays}} \times S$$

sm=min(|H_{L}−S|, |H_{U}−S|, odv)

where vfwd is forward implied volatility, S is the spot exchange rate, H is the touch level and U and L stand for upper and lower respectively, and bizdays is the number of business days to the expected stopping time; then

$$S {D}_{est} = \vert {Delta}_{TVAB} ( {H}_{{L}_{U}} \pm sm , T - ( {t}_{est} - 1 ) ) - {Delta}_{TVAB} ( {H}_{{L}_{U}} , T - {t}_{est} ) \vert$$

SDₑₛₜ is the size of the discontinuity at the expected stopping time, using forward interest rates and forward volatilities.

Therefore, the static asymmetric slippage (SAS) then becomes:

SAS=(SDₑₛₜ×P_{tch}×SF)÷H_{L}_{_{U}}

When there are two touch levels, as for DNT options, the discontinuity is calculated for the touch level with the greatest touch probability.

Since slippage becomes more pronounced as expected stopping time approaches the nominal duration of the American binary option, dynamic asymmetric slippage (DAS) calculates the extension effect of a 1% fall in volatility on expected stopping time:

$$S {D}_{est}^{*} = \vert \begin{matrix}{Delta}_{TVAB} ( {H}_{{L}_{U}} \pm sm , T - ( {t}_{est ( σ - 0.01 )} - 1 ) ) - \\ {Delta}_{TVAB} ( {H}_{{L}_{U}} , T - {t}_{est} )\end{matrix} \vert$$

$$D A S = [ ( {SD}_{est}^{*} \times {P}_{tch} \times S F ) \div {H}_{{L}_{U}} ] - S A S$$

The total asymmetric slippage (AS) then becomes:

AS=SAS+DAS

An alternate but less preferred manner of determining the slippage risk is for it to be a function of the discontinuities of both the expected stopping time of the exotic option and the (nominal) expiration. The size of the discontinuity is the difference in the value of the American Binary Option between the expected stopping time (and nominal expiration) and one day prior when the spot level changes from basis point away, to exactly on, the touch level;

$$S {D}_{EST} = \vert {V}_{TVAB} ( {H}_{{L}_{U}} \pm 0.0001 , T - ( {t}_{EST} - 1 ) ) - {V}_{TVAB} ( H , T - {t}_{EST} ) \vert$$

$$S {D}_{T} = \vert {V}_{TVAB} ( {H}_{{L}_{U}} \pm 0.0001 , T - ( T - 1 ) ) - {V}_{TVAB} ( H , T - T ) \vert$$

where EST is the expected stopping time, T is the expiry date, H is the touch level, and U and L stand for upper and lower, respectively. SD_{EST} is the minimum, and SD_{T} is the maximum discontinuity forecast as at the trade date.

The weighting scheme unique to the present invention utilises the fraction of the American binary option's expected stopping time (EST) to nominal duration (ND) to estimate the risk of the touch occurring sometime later (EXT) than the expected stopping time:

$$EXT = ( ND - EST ) \times ( 1 - \frac{EST}{ND} )$$

The size of the asymmetric slippage (‘AS’) then becomes:

AS=SD_{EXT}×P_{TCH}×SF

where SD_{EXT} is the size of the discontinuity for the date EST+EXT, and P_{TCH} is the risk neutral touch probability. Slippage can also be decomposed into static and dynamic components, though in a somewhat different sense to the preceding analysis. If a price-maker strongly believes that a touch level will trade on or before the expected stopping time, then the additional slippage estimated by the extension above is superfluous. Therefore, the minimum slippage to be applied is that which is attributable to the touch level trading at the expected stopping time (dynamic component).

Intermediate bid (IBid) and offer (IOffer) prices for the American binary option are calculated as part of step 21 as follows:

$$IBid = M V - \frac{BOSpread}{2}$$

$$IOffer = M V + \frac{BOSpread}{2}$$

If the asymmetric slippage is not used the Intermediate bid and offer prices are final. In this event step 20 is omitted.

If asymmetric slippage is used, the final bid and offer prices are calculated to complete step 21 by adjusting either the bid or offer to reflect the asymmetric slippage. The order of steps 20 and 21 is interchangeable. In the event step 21 occurs before step 20, step 20 included applying the AS to IBid or IOffer as appropriate.

For example, a one touch (OT) option:

$$OTBid = M V - \frac{BOSpread}{2} - A S = IBid - AS$$

$$OTOffer = M V + \frac{BOSpread}{2} = IOffer$$

And for a double-no-touch (DNT) option:

$$D N T Bid = MV - \frac{BOSpread}{2} = IBid$$

$$D N T Offer = M V + \frac{B O Spread}{2} + A S = IOffer + A S$$

The bid and offer values are output to a trader to make use of as a guide to their Exotic option trading.

Referring to FIG. 11 a system, typically embodied in the form of a computer 100, for performing the method described above is shown. The computer includes an input means usually in the form of a typical input means of a computer, that is a keyboard and/or mouse and a data input means in the form of a network connection, floppy disk drive or some other transportable memory means; a microprocessor 104; an output means 106, typically in the form of a visual display unit; and a memory 108, typically in the form of random access memory and/or a disk drive. The computer 100 operates under the control of a computer program 110 having instructions for controlling the operation of the processor 104. Typically the computer program 110 is loaded into the main memory of the microprocessor in executable chunks from a disk drive. Although other modes of operation are well known to those skilled in the art.

The input 102 receives the model and market parameters 112 mentioned in step 11 of FIG. 1. These parameters may often be resident on a disk drive of the computer or may be provided by a floppy disk or more typically will be provided through a computer network. Additionally the user may optionally enter parameters including the user specified slippage factor 114 used to calculate step 20 in FIG. 1.

The data received by input 102 is stored in the memory 108. The memory 108 is also used to temporarily store working data and the result data at the end of the method 10. The result data is provided to the output 106, this will include the market value bid and offer prices 116. The output 106 may also provide a graphical representation 118 of these output results and other model or market parameters or information as is desired.

It is typical for the computer program at 110 to be loaded into computer by installing software into the computer under its operating system. Typically the computer program is installed from a computer readable storage medium which will often take the form of a floppy disk, compact disk, DVD, hard disk, flash ram, etc.

### Example

The relative performance of the present invention vis-à-vis the market is outlined below. For DNT options the market values of the present invention are compared to the Universal Volatility Model and actual market values published in Lipton and McGhee (2002). For OT options, the ‘trader rule’ model of Wystup (2003) is chosen as the market benchmark. Wystup (2003) is used because of Hakala and Wystup's (2002, p. 279) claim that this is a “trader's rule of thumb pricing method”, which suggests common usage in the market. The Lipton and McGhee (2002) input data is also used for the OT options so as to illustrate the market supplement adjustment for OT options compared to DNT options.

### DNT Options

Lipton and McGhee (2002) present the following input data for three month DNT options using a spot rate of 0.8750:

TABLE 1
EUR/USD 7 Mar. 2002

| T\Δ | | 10C | 25C | Neutral | 25P | 10P | EUR | USD |
|---|---|---|---|---|---|---|---|---|
| 1 | wk | 10.55 | 9.50 | 8.75 | 8.50 | 8.75 | 3.27 | 1.78 |
| 1 | mo | 9.73 | 8.85 | 8.33 | 8.35 | 8.83 | 3.38 | 1.92 |
| 2 | mo | 9.86 | 8.98 | 8.50 | 8.58 | 9.14 | 3.41 | 1.94 |
| 3 | mo | 10.02 | 9.10 | 8.65 | 8.75 | 9.39 | 3.41 | 1.95 |
| 6 | mo | 10.42 | 9.50 | 9.05 | 9.20 | 9.88 | 3.49 | 2.12 |
| 12 | mo* | 10.72 | 9.80 | 9.35* | 9.50 | 10.18 | 3.75 | 2.65 |
| 24 | mo* | 10.92 | 9.98 | 9.55* | 9.68 | 10.38 | 4.27 | 3.68 |

*The table in Risk appears to have the data for Neutral and 25P reversed for these maturities. This does not affect the analysis which follows, because it is based on a three month maturity.

The performance of the present invention versus the universal volatility model of Lipton and McGhee (2002) and the actual market, is shown in FIG. 5. The difference between both models and the actual market is highlighted in FIG. 6. The output data produced by the present invention is labelled as “Trader Model” or “TM”.

FIGS. 5 and 6 show that the present invention's prices were extremely close to actual market prices for DNTs across a broad range of theoretical values (2.5%≦TV≦47.5%). In almost all instances, the present invention's prices were more accurate than the universal volatility model. In addition, the present invention's prices are also obtained much more easily, owing to the greater computational efficiency of the present invention.

### OT Options

Using the same data as table 1, the present invention's market values for OT options with a touch level above the spot rate (‘up’ OT options) were calculated. ‘Up’ OT options (rather than ‘down’) were chosen by way of example only. The results for up OT options are presented in FIGS. 7, 8 and 9. FIG. 7 shows the relative performance of the present invention's model compared to Wystup (2003).

FIGS. 8 and 9 explain the difference between the present invention's model and the market. FIG. 7 shows the present invention's model without term and strike structures for the per unit costs of ∂vega/∂vol and ∂delta/∂vol. The small variation that remains between the present invention's model and the market is explained by the difference between the risk neutral (no) touch probability and the expected stopping time of the OT (as a percent of nominal duration). FIG. 9 shows that the expected stopping time for the OT is less than the risk neutral (no) touch probability for the range 2.5%≦TV≦65.0%. As a result, the supplement will be less than the market over this range, leading to a lower (higher) price when the supplement is positive (negative).

To demonstrate why the Wystup (2003) method does not extend to DNT options, FIG. 10 shows how the expected stopping time for DNT options differs markedly to the risk neutral (no) touch probability. The probability of the barriers being touched gives no information on when they will be touched, which is particularly important for valuing the market supplement. This is because the market supplement, in effect, is adjusting for the additional hedging costs expected over the life of the American binary option.

The present invention has several advantages:
It is extremely simple.
The nominal duration of the American binary option only indicates the sign of the supplement to theoretical value. The quantum (both size and cost) is defined by the expected stopping time. Therefore, the present invention ensures that hedging costs of American binary options reflect not only the term and strike structure of implied volatility, but also the term and strike structure of ∂vega/∂vol and ∂delta/∂vol. These key convexities can vary considerably both spatially and temporally. Using the correct cost of convexity is crucial, especially when highly competitive markets such as the FX option market require prices to be calculated within very fine tolerances.
It provides new information to price-makers which will assist them in pricing and hedging these at times, dangerous instruments. The present invention quantifies not only the separate effects of the smile and skew on the value of the supplement, but also the crucial contribution of time. This is essential given the strong American optionality of these instruments. The impact of time is so critical, that Taleb (1997, p. 305) describes American binary options as “options on time rather than options on the asset”.
It prices consistently with the implied volatility surface, without requiring additional intermediate calibration (for example, the calculation of local volatilities, jump or stochastic volatility parameters, and/or implied probability distributions). In addition, cross-sectional fitting to exotic markets is not necessary.
It is computationally efficient. Computationally expensive empirical estimation and numerical approximation such as trees, finite difference and Monte Carlo simulation are not necessary. Expected stopping times for single and double barriers have analytical, closed-form solutions.

The present invention attempts to reflect, wherever possible, the actual behaviour of price-makers in the option market. The present invention makes it is easy to price the impact of time, as well as the impact of the smile and skew on the size of the market supplement to theoretical value with a heuristic model. This is a crucial development, as many traders responsible for price-making and book running in the exotic FX option market rely on model outputs (prices) without understanding the limitations of the key assumptions upon which they are based. To hedge, traders need to know the true underlying risk exposures. In this regard, understanding the price and how it changes is as important as the price itself.

The present invention also supports frequent intra-day scenario analysis. Since American binary option greeks are unstable in multiple dimensions, frequent scenario analysis is essential to understanding and hedging the true underlying risk of large, global exotic option books in practice. Frequent intra-day scenario analysis is much more difficult and expensive in models dependent upon complex empirical estimation and numerical approximation routines.

The present invention does not suffer from problems previously attributed to the discredited analytical method, as it is dependent only upon the option contract specifications and the state of the market. Therefore, the present invention correctly values the crucial risk that others' omit, resulting in improvements in both accuracy and efficiency.

Modifications and variations as would be apparent to the skilled addressee are intended to fall within the scope of the present invention.

While the methodology of the present invention applies to exotic options in general, the preferred embodiment described in this application, by way of example only, is specific to American binary FX options. Since it is easy to apply the methodology to different products and different markets, the example should not be considered a limit on the scale or scope of this application.

Accordingly such modifications and variations as would be apparent to a person skilled in the art are intended to fall within the scope of the present invention, the nature of which is intended to be determined by the foregoing description and appended claims.

1-52. (canceled)

53. A computer implemented method of obtaining the market value of an exotic option, comprising the steps of:
providing market and option contract input data;
calculating a theoretical value of the exotic option from the input data;
calculating a market supplement adjustment to the theoretical value as a function of the expected stopping time of the exotic option; and
applying the market supplement adjustment to the theoretical value to produce the market value.

54. A method according to claim 53, wherein the market value is used to calculate bid-offer prices.

55. A method according to claim 54, wherein a bid-offer spread is calculated from the input data.

56. A method according to claim 55, wherein the bid-offer spread is also a function of the expected stopping time of the exotic option.

57. A method according to claim 56, wherein a bid price and an offer price of the exotic option are calculated as a function of the market value and the bid-offer spread.

58. A method according to claim 56, wherein a bid price and an offer price of the exotic option are calculated as a function of the market value, the bid-offer spread and an asymmetric slippage adjustment.

59. A method according to claim 58, wherein the asymmetric slippage adjustment is calculated from the input data and a function of the expected stopping time of the exotic option.

60. A computer implemented method of obtaining bid and offer prices of an exotic option, comprising the steps of:
providing market and option contract input data;
calculating a theoretical value of the exotic option from the input data;
calculating a market supplement adjustment to the theoretical value that incorporates the expected stopping time of the exotic option;
calculating the bid-offer spread from the input data and a function of the expected stopping time of the exotic option; and
calculating bid and offer prices of the exotic option as a function of the theoretical value, market supplement adjustment, and bid-offer spread.

61. A method according to claim 60, wherein adjusted bid-offer prices are calculated from an asymmetric slippage adjustment and the calculated bid-offer spread.

62. A method according to claim 61, wherein the asymmetric slippage adjustment is calculated from the input data and a function of the expected stopping time of the exotic option.

63. A method according to claim 60, wherein the theoretical value is obtained by applying the no-arbitrage methods of Black-Scholes and Merton to exotic payoffs.

64. A method according to claim 63, wherein whenever the theoretical value of an option is dependent on the solution of an infinite sum, a finite number of elements are summed to ensure at least a five digit accuracy.

65. A method according to claim 60, wherein the market supplement adjustment is a function of the input data only.

66. A method according to claim 60, wherein the market supplement adjustment is calculated from a Convexity to Implied Volatility Adjustment and a Market Weight Adjustment.

67. A method according to claim 66, wherein the Convexity to Implied Volatility Adjustment is calculated with reference to the ∂vega/∂vol and ∂delta/∂vol of the exotic option, and of the relevant vega neutral butterfly and relevant risk reversal.

68. A method according to claim 67 wherein one of the steps of calculating the per unit price of ∂vega/∂vol is identifying the relevant vega neutral butterfly.

69. A method according to claim 68 wherein the vega neutral butterfly is identified using a term to maturity equal to the expected stopping time of the exotic option and a minimum delta.

70. A method according to claim 69 wherein the minimum delta of the relevant vega neutral butterfly is chosen to match the delta of the touch level(s) at the expected stopping time.

71. A method according to claim 70 wherein when there are two asymmetric touch levels, the minimum absolute delta is selected for the vega neutral butterfly.

72. A method according to claim 69, wherein the price per unit of vega convexity to implied volatility is calculated from the zeta of the vega neutral butterfly and its ∂vega/∂vol.

73. A method according to claim 67 wherein one of the steps of calculating the per unit price of ∂delta/∂vol is identifying the relevant risk reversal.

74. A method according to claim 73, wherein the risk reversal is identified using a term to maturity equal to the expected stopping time of the exotic option and the minimum delta.

75. A method according to claim 74, wherein the minimum delta of the equivalent risk reversal is chosen to match the delta of the touch level(s) at the expected stopping time.

76. A method according to claim 75, wherein when there are two asymmetric touch levels, the minimum absolute delta is selected for the risk reversal.

77. A method according to claim 74, wherein the price per unit of delta convexity to implied volatility is calculated from the zeta of the risk reversal and its ∂delta/∂vol.

78. A method according to claim 66, wherein the Market Weight Adjustment is calculated from the expected stopping time of the exotic option and the nominal duration of the exotic option.

79. A method according to claim 78, wherein the market supplement adjustment is calculated from a vega convexity value and a delta convexity value.

80. A method according to claim 79, wherein the vega convexity value is calculated from ∂vega/∂vol, the market weight adjustment, the per unit price of vega convexity and the touch probability.

81. A method according to claim 79, wherein the delta convexity value is calculated from ∂delta/∂vol, the market weight adjustment, the per unit price of delta convexity and the touch probability.

82. A method according to claim 61, wherein a mid-market value is calculated from the theoretical value and the value of the market supplement adjustment.

83. A method according to claim 61, wherein the bid-offer spread is calculated such that it is independent of arbitrary constants and dependent only on the input data.

84. A method according to claim 61, wherein the bid-offer spread is calculated from a Static Spread Adjustment and a Dynamic Spread Adjustment. Preferably the Static Spread Adjustment includes a contribution from vega.

85. A method according to claim 84, wherein the Static Spread Adjustment includes a contribution from ∂vega/∂vol.

86. A method according to claim 84, wherein the Dynamic Spread Adjustment includes a contribution from ∂vega/∂vol.

87. A method according to claim 84, wherein the Static Spread Adjustment includes a contribution from ∂delta/∂vol.

88. A method according to claim 84, wherein the Dynamic Spread Adjustment includes a contribution from ∂delta/∂vol.

89. A method according to claim 84, wherein the Static Spread Adjustment includes a contribution from the expected life of the option.

90. A method according to claim 84, wherein the Dynamic Spread Adjustment includes a contribution from the expected life of the option.

91. A method according to claim 61, wherein the bid-offer spread is supplemented by an asymmetric slippage component which has static and dynamic components.

92. A method according to claim 82, wherein bid and offer prices are calculated from the mid-market value and the supplemented bid-offer spread.

93. A system for calculating a market value of an exotic option comprising:
input means for receiving market and option contract input data;
means for calculating a theoretical value of an exotic option from the input data;
means for calculating a market supplement adjustment to the theoretical value as a function of the expected stopping time of the exotic option;
means for applying the market supplement adjustment to the theoretical value to produce the market value; and
output means for outputting the calculated market value.

94. A system for obtaining bid and offer prices of an exotic option comprising:
input means for receiving market and option contract input data;
means for calculating a theoretical value of an exotic option from the input data;
means for calculating a market supplement adjustment to the theoretical value that incorporates the expected stopping time of the exotic option;
means for calculating a bid-offer spread from the input data as a function of the expected stopping time of the exotic option;
means for calculating bid and offer prices of the exotic option as a function of the theoretical value, market supplement adjustment and bid offer spread; and
output means for outputting the calculated bid and offer prices.

95. A computer program for controlling a computer to perform the methods of claim 53.

96. A computer program for controlling a computer to perform the methods of claim 60.

97. A computer program comprising instructions to operate a computer as the systems of claim 95.

98. A computer program comprising instructions to operate a computer as the systems of claim 96.

99. A computer readable storage medium comprising a computer program as defined in claim 97.

100. A computer readable storage medium comprising a computer program as defined in claim 98.

101. A computer readable storage medium comprising a computer program as defined in claim 99.

102. A computer readable storage medium comprising a computer program as defined in claim 100.
